(19) United States
(12) Patent Application Publication
(10) Pub. No.: US 2026/0193576 A1
(43) Pub. Date: Jul. 9, 2026

(54) CLEANING SOLUTION FOR CLEANING AN OBJECT PRODUCED USING A 3D PRINTING METHOD

(71) Applicant: Franca SCHMID, St. Gallen (CH)

(72) Inventors: Raphael SCHAEFFLER, Arbon (CH); Adalbert SCHMID, Rebstein (CH); Christoph EVERS, Rebstein (CH); Franca SCHMID, St. Gallen (CH)

(21) Appl. No.: 19/132,234

(22) PCT Filed: Aug. 25, 2023
(86) PCT No.: PCT/CH2023/050030

§ 371 Date: May 22, 2025

(30) Foreign Application Priority Data
Nov. 22, 2022 (CH) CH001388/2022

(51) Int. Cl. C11D 7/50; A61C 19/00; B29C 64/30; B29C 71/00; B29K 33/00; B29K 509/08; B29L 31/00; B33Y 40/00; B33Y 80/00

(52) U.S. Cl. CPC C11D 7/5022; A61C 19/002; B29C 64/30; B29C 71/0009; B33Y 40/00; B33Y 80/00; B29C 2071/0027; B29C 2071/0045; B29K 2033/12; B29K 2509/08; B29L 2031/753; B29L 2031/7536

(57) ABSTRACT

The invention relates to a cleaning solution for cleaning an object produced using a 3D printing method, to a method for cleaning an object produced using a 3D printing method by means of the cleaning solution according to the invention, and to the use of the cleaning solution according to the invention to clean an object produced using a 3D printing method. The cleaning solution according to the invention comprises a carbonate and water.

The invention relates to a cleaning solution for cleaning an object produced using a 3D printing method, a method for cleaning an object produced using a 3D printing method using the cleaning solution according to the invention, and the use of the cleaning solution according to the invention for cleaning an object produced using a 3D printing method.

3D printing methods have been known in the prior art for some time. These methods are manufacturing methods in which material is deposited layer by layer to create 3D (three-dimensional) objects or workpieces. The material to be deposited is typically plastic or synthetic resin, but also ceramic. 3D printing methods are used, for example, in mechanical and automotive engineering, that is to say, also in the aerospace industry, and medical and dental technology.

Objects produced using a 3D printing method should be cleaned after production and/or before use to remove any residues from the manufacturing method from their surface. These residues could be, for example, remnants of unpolymerized resin. This is particularly important in the dental field, as objects produced using a 3D printing method, especially dental objects, are used or inserted in the oral cavity of patients.

This cleaning can be done by hand, using ultrasonic baths, or using the now widely used mechanical cleaning method (e.g., RS wash cleaning device [Rapid Shape; Heimsheim; Germany]; Prowash/Dry [Sprintray; Los Angeles; USA]). The most commonly utilized cleaning method is using ultrasonic baths. In this case, a solvent/cleaning agent is placed in a beaker, the object to be cleaned is added, and the object is cleaned for a specific time using an ultrasonic bath. This method is usually repeated in a beaker using clean solvent. Mechanical cleaning usually follows a similar principle (first a pre-cleaning followed by a post-cleaning), wherein typical solvents such as isopropanol or ethanol are also used.

Hand cleaning produces the best results in terms of method, but is not widely used in practice due to convenience. A cloth or brush soaked in solvent is used for cleaning. Due to visual inspection residues are removed very effectively, and the short exposure time of the solvent has the least impact on the material properties/physics of the finished object.

Isopropanol is the most commonly used solvent/cleaning agent in 3D printing. However, the use of isopropanol as a cleaning fluid is associated with several disadvantages. Firstly, the use of isopropanol can lead to the formation of flammable or explosive mixtures or the formation of harmful vapors. Secondly, if the cleaning agent is left on the object for too long, it can penetrate the surface of the object, negatively impacting the material properties. Furthermore, used isopropanol, which is contaminated with resin, must be disposed of after cleaning, which is a complex method. Ethanol, which is also quite commonly used, has similar properties.

In addition to isopropanol, cleaners based on high-boiling glyme compounds have recently become available. Glyme compounds are ethylene glycol chains used as solvents for cleaning. While this eliminates the fire hazard, the other two disadvantages remain.

Cleaning is particularly problematic for filled 3D printing resins, as the fillers can form a white film on the printed restoration after cleaning, which then requires laborious removal. Such filled resins are primarily used in dentistry, such as composites, which comprise a plastic matrix with fillers or infill structures dispersed therein.

DE 10 2019 123 104 A1 discloses a method for cleaning an object produced using a 3D printing method, in particular a dental molded part produced using a 3D printing method. The method utilizes a gas stream to remove adhering remnants from the 3D object.

It is an object of the invention to overcome the above-mentioned disadvantages of the prior art.

It is a further object of the invention to provide a cleaning solution which cleans 3D-printed objects of residues and/or dirt and at the same time does not negatively impact the material properties of the 3D-printed object to be cleaned, in particular a 3D-printed dental object to be cleaned.

It is also an object of the invention to provide a cleaning solution which cleans 3D objects made of composite and at the same time does not leave a white film on the cleaned 3D object.

It is a further object of the invention to provide a method for cleaning objects produced by a 3D printing method, wherein the method should be simple and fast.

The invention therefore provides a cleaning solution for cleaning 3D-printed objects, characterized in that the cleaning solution comprises a carbonate and water. Carbonates are esters of carbonic acid, the preparation of which is known in the prior art. Surprisingly, it has also been found that particularly good results are achieved within a close mixing ratio between water and carbonate in the cleaning solution.

The invention offers numerous advantages. By means of the cleaning solution according to the invention, objects produced using a 3D printing method can not only be reliably cleaned, but their material properties, such as flexural strength, can also be preserved.

A further advantage of the invention lies in the cleaning of objects made of composite which are produced by means of a 3D printing method. A composite comprises, or consists of, a plastic matrix with fillers or infill structures dispersed therein. The fillers or infill structures are typically made of glass or quartz, which are dispersed in the matrix. After cleaning such composite-containing 3D objects, no white film remains on the surface of the cleaned 3D-printed objects.

Recycling is a further advantage of the invention. After the cleaning procedure, the used cleaning solution can be recycled by exposure to light and subsequent filtration. Resin residues detached from the cleaned 3D object harden and can then be easily removed.

Suitable carbonates include, but are not limited to organic carbonates such as diethyl carbonate (CAS No. 105-58-8), ethylene carbonate (CAS No. 96-49-1), propylene carbonate (CAS No. 108-32-7), and butylene carbonate (CAS No. 4437-85-8). Propylene carbonate exists in the form of two stereoisomers (CAS No. 51260-39-0 and CAS No. 16606-55-6, respectively), each of which can be used individually or as a racemic mixture.

The carbonate is preferably selected from the group consisting of diethyl carbonate, ethylene carbonate, propylene carbonate, butylene carbonate, and mixtures thereof. The carbonate may therefore comprise not only a single component, such as propylene carbonate, but may also comprise a mixture of, for example, ethylene carbonate and propylene carbonate. If the carbonate is present as a mixture of two or more components, the mixing ratios between the two or more components can be chosen freely.

Preferably, the carbonate comprises propylene carbonate, more preferably the carbonate consists of propylene carbonate.

The mixing ratio of carbonate to water in the cleaning solution varies from carbonate to carbonate and depends on the miscibility of the carbonate with water. For example, the mixing ratio of the preferred propylene carbonate to water in the cleaning solution is preferably between 17:83 and 21:79 percent by weight, more preferably between 18:82 and 20:80 percent by weight, and most preferably between 18.5:81.5 and 19.5:80.5 percent by weight, based on the total weight of the cleaning solution.

The water can preferably be distilled water or non-distilled water. Non-distilled water is, for example, tap water or spring water. Non-distilled water usually contains trace elements, organic substances, microorganisms, and/or other contaminants that can reduce the quality of the water. In principle, non-distilled water can also be used for the cleaning solution according to the invention, particularly if its water quality or purity is sufficient. Otherwise, distilled water is preferable. The water is preferably distilled water.

The cleaning solution may additionally contain a solvent such as isopropanol, ethanol, acetone, or a glycol compound and/or a glyme compound. Preferably, however, the cleaning solution does not contain any of these solvents, glycol compounds, and/or glyme compounds.

The invention further provides a method for cleaning an object produced using a 3D printing method. The method for cleaning an object produced using a 3D printing method comprises, or consists of, the steps of
a) providing an object produced using a 3D printing method,
b) cleaning the object produced using a 3D printing method with a cleaning solution according to the invention.

Preferably, the object produced using a 3D printing method is a dental object.

Preferably, the dental object includes, but is not limited to a denture base, a model of a denture base, a denture tooth, a model of a denture tooth, a dental crown, a model of a dental crown, a filling, a model of a filling, dentures, a model of artificial dentures, a dental model, a model of an oral cavity for setting up a dental prosthesis, a bite splint, a drilling template, an individual impression tray, a gum mask, a complete denture, a model of a complete denture, a try-in, an orthodontic appliance, an inlay, a model of an inlay, an onlay, a model of an onlay, a veneer, a model of a veneer, an implant, a model of an implant, a bridge construction, or a model of a bridge construction.

The dental object preferably comprises a composite, or the dental object preferably consists of a composite. The composite preferably comprises or consists of a plastic matrix and a filler. The plastic matrix preferably comprises or consists of an acrylate resin, an epoxy resin, or a vinyl ester resin. All resins are preferably cured, i.e., already fully polymerized. The acrylate resin preferably comprises or consists of a methacrylate resin. The methacrylate resin preferably comprises bis-glycidyl dimethacrylate resin (BisGMA) and/or urethane dimethacrylate resin (UDMA).

Preferably, the filler comprises an inorganic filler or the filler consists of an inorganic filler. The inorganic filler preferably comprises or consists of a glass and/or quartz; more preferably, the inorganic filler comprises a glass. The glass preferably comprises or consists of a dental glass. Dental glass is commercially available, for example, from Schott AG.

In a preferred embodiment, the composite comprises a methacrylate resin, in particular a cured methacrylate resin, and dental glass.

The cleaning time in step b) is preferably 1 to 10 minutes, more preferably 2 to 4 minutes. Cleaning in step b) can be done manually or mechanically. Manual cleaning is, for example, cleaning the 3D-printed object using a brush or sponge while using the cleaning solution according to the invention. Mechanical cleaning is, for example, cleaning the 3D-printed object in an ultrasonic bath while using the cleaning solution according to the invention or by cleaning the 3D object in a separate device such as RS wash (Rapid Shape; Heimsheim; Germany).

Cleaning in step b) is preferably done mechanically, preferably in an ultrasonic bath.

Cleaning step b) can be performed once or repeated, the latter particularly to remove stubborn contaminants and/or residues on the surface of the 3D-printed object to be cleaned. These residues are typically residues of materials used in the manufacturing method.

Cleaning step b) is preferably repeated, with each repetition of step b) being performed using a fresh cleaning solution. Fresh cleaning solution is understood to mean an unused or new cleaning solution.

All preferred embodiments of the cleaning solution according to the invention, as described herein, are also preferred embodiments of the method according to the invention for cleaning an object produced using a 3D printing method, where applicable.

The present invention further provides the use of the cleaning solution according to the invention for cleaning an object produced using a 3D printing method.

All preferred embodiments of the cleaning solution according to the invention, as described herein, as well as all preferred embodiments of the method according to the invention for cleaning an object produced using a 3D printing method are also preferred embodiments of the use according to the invention, if applicable.

The invention will now be explained in more detail with reference to the following examples.

### EXAMPLES

### Measurement Methods

Flexural strength was measured using 2×2×25 mm³ printed rods according to DIN EN ISO 4049 [Dentistry-Polymer-based restorative materials (ISO 4049:2019)]. Flexural strength is considered the most suitable physical parameter in the dental field.

The cleaning effect was assessed visually. The homogeneity of the cleaning solutions was also assessed visually.

### Cleaning Tests

In a series of tests, dental crowns produced using a 3D printing method were cleaned using conventional cleaning agents as well as the cleaning solution according to the invention.

The 3D-printed dental crowns or rods comprise a methacrylate-based 3D resin (Crowntec, Saremco Dental AG) provided with a dental glass filler. The cleaning times are as indicated in Tables 1 and 2. In the case of two cleaning steps, e.g., two 3-minute cleaning steps, fresh conventional cleaning agent or cleaning solution according to the invention was always used for the second cleaning step.

The cleaning method “ultrasonic bath with isopropanol, ethanol or butyl diglycol” resulted in a deterioration of the physical properties of the cleaned objects (Table 1). In addition, a whitish layer formed on the surface of the dental crowns. All tests were carried out at room temperature. The results can be found in Table 1 below.

TABLE 1
Results of cleaning tests with different cleaning methods;
if two cleaning times are given, the second cleaning
was always carried out with a new, clean solvent.

| | | Flexural | Cleaning |
|---|---|---|---|
| Cleaning method | Cleaning effect | strength [MPa] | time |
| Ethanol; | good | >140 | 5 min |
| Manual cleaning | | | |
| without ultrasonic | | | |
| bath | | | |
| Ethanol; | moderate | 90.05 | 1 × 3 min + |
| ultrasonic bath | (whitish layer | | 1 × 3 min |
| | remains) | | |
| Isopropanol; | moderate | 84.86 | 1 × 3 min + |
| ultrasonic bath | (whitish layer | | 1 × 3 min |
| | remains) | | |
| Metanova Cleaning | moderate | 102.10 | 1 × 3 min + |
| Liquid*; | (whitish layer | | 1 × 3 min |
| ultrasonic bath | remains) | | |

*Metanova Cleaning Liquid [Metaux Precieux Dental GmbH; Stuttgart] contains butyl diglycol (CAS No. 112-34-5).

A cleaning agent according to the invention made from water and propylene carbonate (PC) was then used, and the mixing ratio of water to propylene carbonate was varied, see Table 2. It was found that at mixing ratios of water to PC greater than 82:18 wt. %, the cleaning effect decreases somewhat. At concentrations less than 75:25 wt. %, the cleaning effect is very good, but the flexural strengths are reduced. A whitish layer was not observed. All tests were carried out at room temperature. The results can be found in Table 2 below.

TABLE 2
Results of the cleaning tests with different mixing ratios of water
to propylene carbonate (PC); if two cleaning times are given, the
second cleaning was always carried out with a new, clean solvent.

| Mixing ratio | Homogenous | Cleaning effect | Flexural | Cleaning time |
|---|---|---|---|---|
| water:PC, wt. % | mixture | (ultrasonic bath) | strength [MPa] | (ultrasonic bath) |
| 50:50 | no | good | 86.10 | 1 × 3 min |
| 70:30 | no | good | 78.03 | 1 × 3 min |
| 75:25 | no | good | 119.52 | 1 × 3 min + |
| | | | | 1 × 2 min |
| 80:20 | no | moderate | 131.47 | 1 × 3 min |
| | | (sticky surface) | | |
| 80:20 | no | good | 113.04 | 1 × 3 min + |
| | | | | 1 × 3 min |
| 81:19 | yes | good | 132.96 | 1 × 3 min + |
| | | | | 1 × 3 min |
| 82:18 | yes | moderate | n.m. | 1 × 3 min + |
| | | (sticky surface) | | 1 × 3 min |
| 85:15 | yes | moderate | n.m. | 1 × 3 min + |
| | | (sticky surface) | | 1 × 3 min |

n.m. not measured

As the table shows, many different mixing ratios were tested. It was found that a mixture of 81±0.5 wt. % water with 19±0.5 wt. % propylene carbonate produced the best results. With higher water content, the cleaning effect decreased; with higher propylene carbonate content, the cleaning effect remained approximately the same, but the physical properties decreased. In addition, the cleaning solution separated, making the cleaning procedure more difficult.

By adding solvent, it is possible to prevent separation into two phases. Table 3 shows the results of such measurements. Here, the mixture of water:carbonate, which is not homogeneous under normal conditions, was used in a ratio of 80:20 and a small amount of solvent was added.

TABLE 3
Results of cleaning tests with mixing ratios of water to propylene
carbonate (PC) to a solubilizer; if two cleaning times are given,
the second cleaning was always carried out with a new, clean solvent.

| Mixing ratio | | | | |
|---|---|---|---|---|
| water:PC:solubilizer, | Homogenous | Cleaning effect | Flexural | Cleaning time |
| wt. % | mixture | (ultrasonic bath) | strength [MPa] | (ultrasonic bath) |
| 79.21:19.8:0.99 | yes | good | 111.05 | 1 × 3 min + |
| solubilizer; | | | | 1 × 3 min |
| isopropanol | | | | |
| 79.21:19.8:0.99 | yes | good | 113.87 | 1 × 3 min + |
| solubilizer; | | | | 1 × 3 min |
| ethanol | | | | |

As the table shows, homogeneous mixtures can be produced this way. The physical properties are reduced, but still significantly better than those with the pure solvents. Furthermore, no whitish layer remains. The results without the solubilizer, however, are even better compared to these homogeneous mixtures. Nevertheless, the homogeneity range can be further expanded. This is particularly important if the cleaner is to be used at lower temperatures, as demixing can occur under such conditions. Furthermore, in this way, the cleaning effect can be improved at lower propylene carbonate contents.

1. A cleaning solution for cleaning an object produced using a 3D printing method, characterized in that the cleaning solution comprises a carbonate and water.

2. The cleaning solution according to claim 1, wherein the carbonate is selected from the group consisting of diethyl carbonate, ethylene carbonate, propylene carbonate, butylene carbonate, and mixtures thereof.

3. The cleaning solution according to claim 1, wherein the carbonate comprises propylene carbonate or consists of propylene carbonate.

4. The cleaning solution according to claim 1, wherein the carbonate consists of propylene carbonate.

5. The cleaning solution according to claim 1, wherein the mixing ratio of propylene carbonate to water in the cleaning solution is between 17:83 percent by weight and 21:79 percent by weight, based on the total weight of the cleaning solution.

6. The cleaning solution according to claim 1, wherein the mixing ratio of propylene carbonate to water in the cleaning solution is between 18.5:81.5 percent by weight and 19.5:80.5 percent by weight, based on the total weight of the cleaning solution.

7. The cleaning solution according to claim 1, wherein the water is distilled water.

8. A method for cleaning an object produced using a 3D printing method, comprising the steps of
a) providing an object produced using a 3D printing method, and
b) cleaning the object produced using a 3D printing method with a cleaning solution according to claim 1.

9. The method according to claim 8, wherein the object produced using a 3D printing method is a dental object.

10. The method according to claim 8, wherein the dental object is a denture base, a model of a denture base, a denture tooth, a model of a denture tooth, a dental crown, a model of a dental crown, a filling, a model of a filling, dentures, a model of artificial dentures, a dental model, a model of an oral cavity for setting up a dental prosthesis, a bite splint, a drilling template, an individual impression tray, a gum mask, a complete denture, a model of a complete denture, a try-in, an orthodontic appliance, an inlay, a model of an inlay, an onlay, a model of an onlay, a veneer, a model of a veneer, an implant, a model of an implant, a bridge construction, or a model of a bridge construction.

11. The method according to claim 8, wherein the dental object comprises a composite.

12. (canceled)
